(19) United States
(12) Patent Application Publication
(10) Pub. No.: US 2025/0305294 A1
(43) Pub. Date: Oct. 2, 2025

(54) ARCHITECTURAL FAÇADE WITH MULTIPLE DISPLAY SURFACES

(71) Applicants: Voss Automotive, Inc., Fort Wayne, IN (US); Voss Automotive GmbH, Wipperfurth (DE)

(72) Inventors: Eduardo Vultorius, Fort Wayne, IN (US); Amy Collins, Fort Wayne, IN (US); Jill Saylor, Fort Wayne, IN (US); Tyler Hartman, Fort Wayne, IN (US); Brian McGregor, Fort Wayne, IN (US); Connor Ort, Fort Wayne, IN (US); Reinhard Plietsch, Wipperfurth (DE); Anne Voelkel, Wipperfurth (DE)

(73) Assignees: Voss Automotive, Inc., Fort Wayne, IN (US); Voss Automotive GmbH, Wipperfurth (DE)

(21) Appl. No.: 19/088,663

(22) Filed: Mar. 24, 2025

Related U.S. Application Data
(60) Provisional application No. 63/570,704, filed on Mar. 27, 2024.

(51) Int. Cl. E04F 13/08; H02S 20/26; H02S 20/30

(52) U.S. Cl. CPC E04F 13/0871; H02S 20/26; H02S 20/30

(57) ABSTRACT

A modular unit for use in an architectural façade system includes a frame, at least one multiple-sided chamber rotatably mounted on the frame, a motor mounted on the frame, a transmission for transferring rotational output from the motor to cause rotation of the multiple-sided chamber, a controller for operating the motor, and wherein at least one of the sides of the chamber displays one of a solar array, horticultural greenery, and a light-emitting display panel.

### CROSS-REFERENCE TO RELATED APPLICATIONS

This application claims priority to Provisional Application No. 63/570,704, filed Mar. 27, 2024, which is incorporated herein by reference in its entirety.

### FIELD OF THE DISCLOSURE

This disclosure relates to architectural façades and, more particularly, to enhanced architectural facades capable of displaying multiple aesthetic or functional surfaces.

### SUMMARY OF THE DISCLOSURE

The following disclosure presents an exterior and/or interior system with modular units having rotatable multi-sided chambers. The multi-sided chambers may include but are not limited to any combination of LED or LCA, solar charging, botanical greenery, artwork or design features, and speakers. A computer-controlled water irrigation system can be incorporated to irrigate the live botanical greenery and clean the solar arrays. The disclosed system enhances and accentuates an existing exterior and/or interior building wall, façade, envelope, cladding structure, or entertainment space. The system can be climate neutral, self-sufficient, and low maintenance with the intent to support sustainable clean energy and reduction of CO₂ emissions. The system can be manufactured for implementation on exterior and interior building walls and structures and is supported by either an attached or detached mounting system. The system and units thereof can be solar-powered and/or connected directly to existing shore power resources.

### BRIEF DESCRIPTION OF THE DRAWINGS

The embodiments may be better understood from the following detailed description with reference to the drawings, which are not necessarily to scale and in which:

FIG. 1 illustrates a chassis or frame system 100 for supporting the components of a system unit, wherein the chassis or frame system 100 includes a plurality of horizontal 110 and vertical 120 support members fixedly connected to each other.

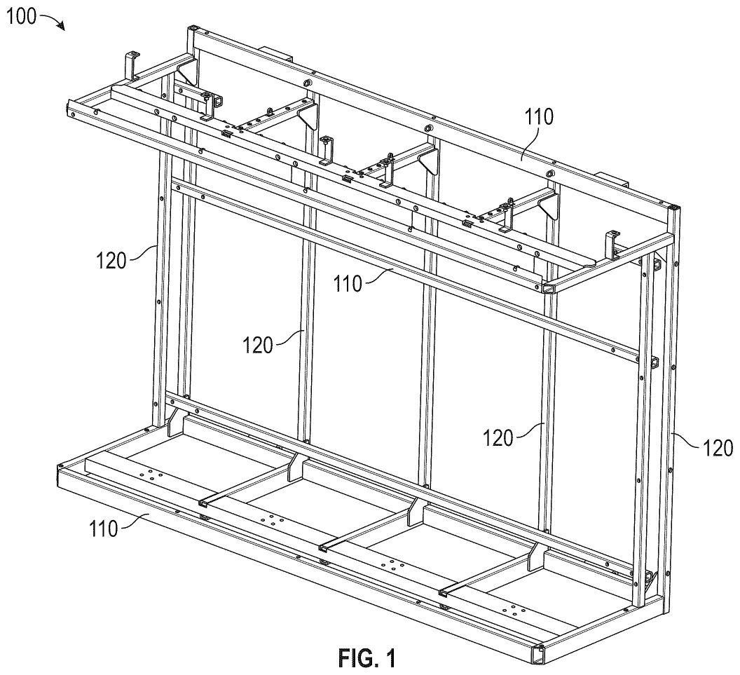

FIG. 2 illustrates an assembly view 200 with the frame of FIG. 1 additionally including wiring 210 for powering lighting displays and/or storing energy from solar cells.

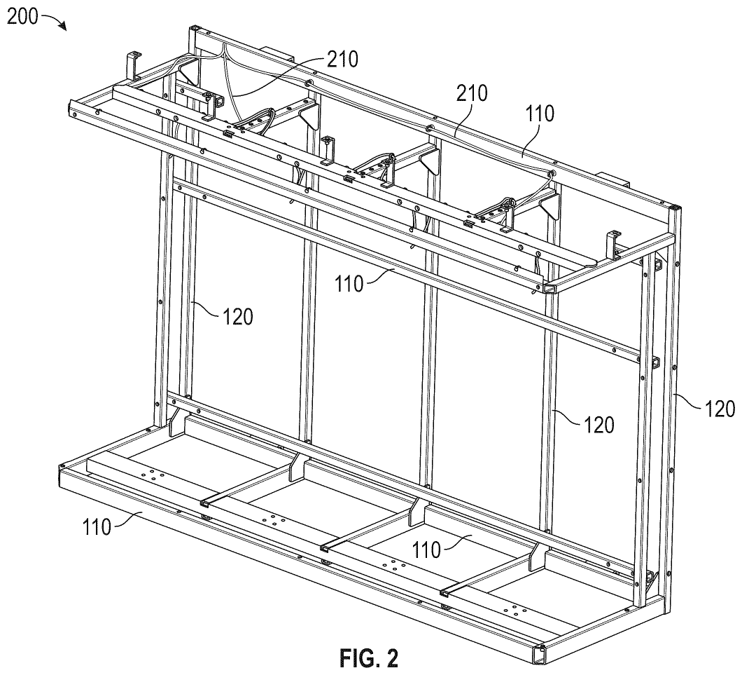

FIG. 3 illustrates an assembly view 300 with the components illustrated in FIG. 2, the chassis or frame system 100 of FIG. 1, and an axle 310.

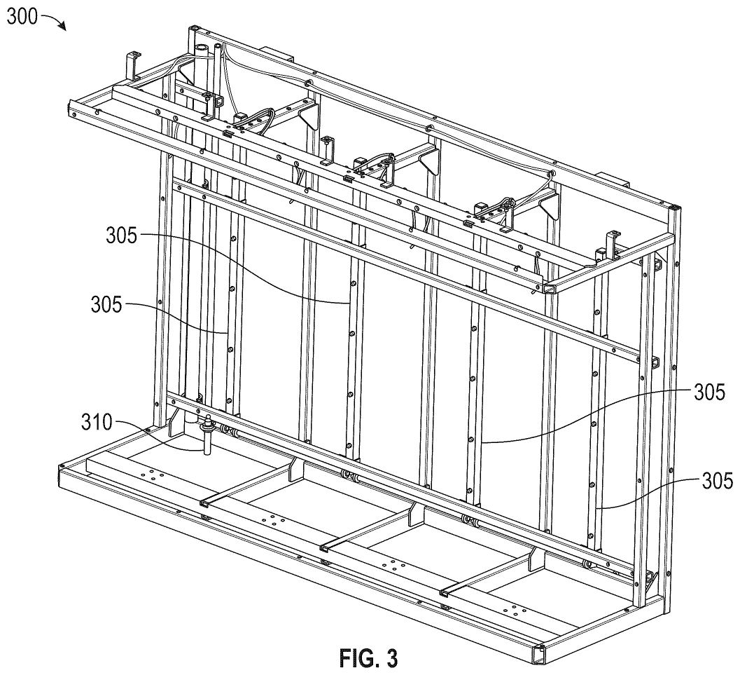

FIG. 4 illustrates an assembly view 400 with the components illustrated in FIGS. 1-3 including an upper rotational motion transmission 420.

FIG. 5 illustrates an assembly view 500 with the components illustrated in FIGS. 1-4 including a set of multi-sided chambers 510 mounted to the rotational motion transmission system, wherein the set of multi-sided chambers are rotated in a first position having a first outward facing side 520.

FIG. 6 illustrates an assembly view 600 with the components illustrated in FIGS. 1-5, wherein the set of multi-sided chambers 510 is rotated in a second position having a second outward-facing side 610.

FIG. 7 illustrates an assembly view 700 with the components illustrated in FIGS. 1-5, wherein the set of multi-sided chambers 510 are rotated in a third position having a third outward-facing side 710.

### DETAILED DESCRIPTION

An exterior and/or interior building façade system includes modular rotating multi-sided chambers. Each individual side can comprise a solar array 710, LED or LCA communication display 610, live botanical greenery 520, art/design features, speakers, and a computer-controlled water irrigation system 305 to irrigate the live botanical greenery and clean the solar array. The disclosed system can be designed to enhance and accentuate an existing exterior and/or interior building façade, envelope, cladding structure, advertising, or entertainment space. The system can be climate neutral, self-sufficient, low maintenance, and/or capable of supporting sustainable clean energy and reducing CO₂ emissions.

The illustrated embodiments are described as having a motor, a battery, controllers, and irrigation system shut-off valves. These items can be mounted on the frame of the modular unit, or the motor, battery, controllers and shut-off valves can be located remote from the modular unit, such as on a building roof, a mechanical room, or other secondary location.

Frame system 100 and other module unit structures can be fabricated of, but are not limited to, aluminum extrusions, steel extrusions, or carbon fiber tubes to house the multi-sided chamber sub-systems (LED or LCA, greenery, solar charging, artwork/design feature, or speaker); wherein the extruded design gives continuous structure along the length of the modular panel; wherein the extruded design also provides mounting surfaces for the internal chambers that allow mounting of the LED or LCA, solar arrays, plant media, artwork design features, or speakers.

The modular unit can be configured to provide a weather resistant casing to shield components from adverse weather conditions, and the multi-sided chambers can be capable of being locked in a position to protect internal components during severe weather. A Control Interface Module (CIM) or User Interface (UI) can be programmed and used to control the entire unit's system functions and performance. The CIM or UI may also monitor energy storage and usage, weather, LED or LCA display messaging and programming, the façade/greenery substrate/soil moisture and nutrient pH levels, and customer-specific features like speakers and cameras.

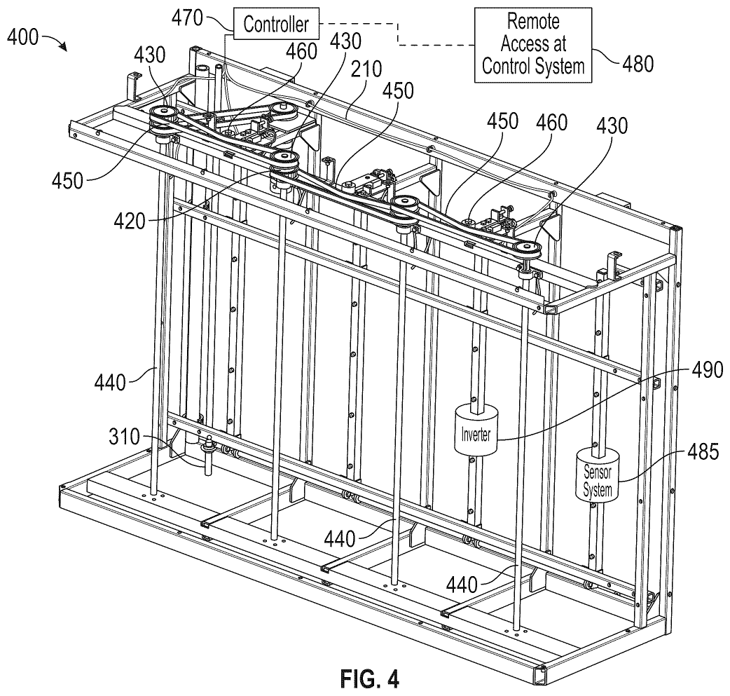

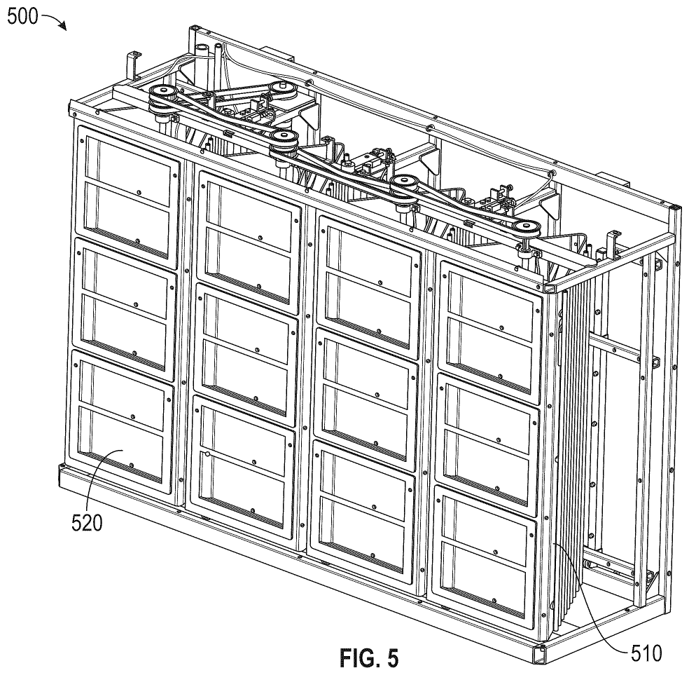

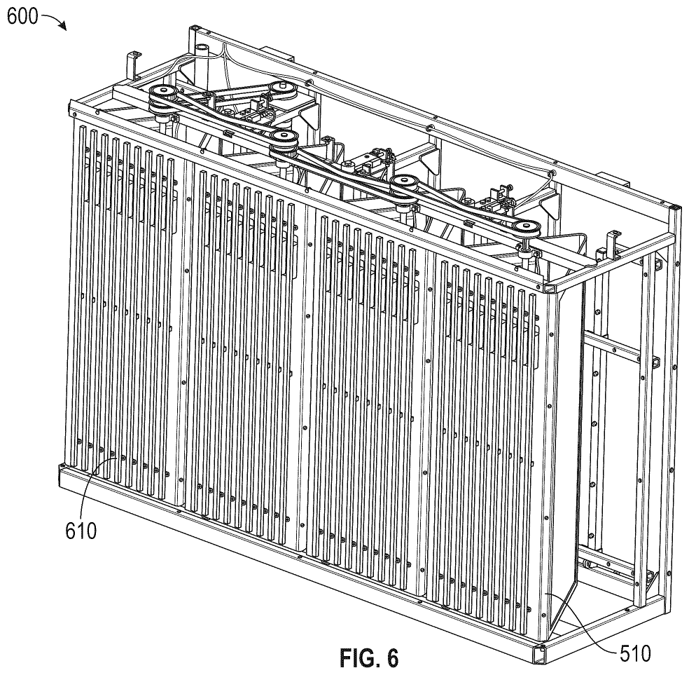

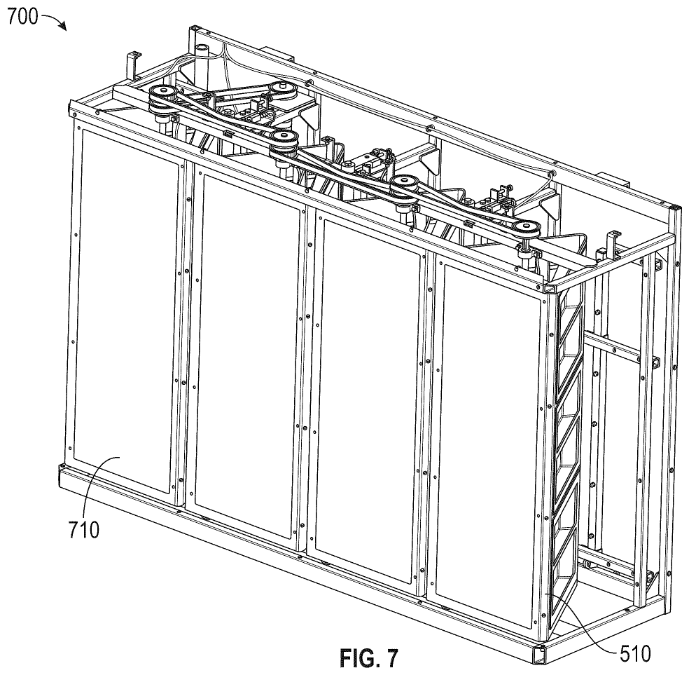

The multisided module chambers rotate mechanically by power transmission components like but not limited to pivot axles, pullies, belts, tensioners, linkages, chains, or any combination of components. Illustrated rotational transmission 420 (FIGS. 4-7) includes pulleys 430 joined to axles 440 coupled to a motor (not shown) and chamber 510. Drive belts 450 transfer rotational output from the motor into rotational motion of chamber 510. Tensioner pulleys 460 can be provided to maintain tension on belts 450. For systems including a chamber 510 configured to support greenery, a drain pan (not shown) can be provided to collect excess runoff during and after irrigation, and a debris guard (not shown) can collect any plant matter that is separated from the greenery. A controller 470 (schematically illustrated in FIG. 4) is provided for operating or controlling the motor to position a particular side of the chamber 510 at the front of frame 100.

Solar array 710 can be electrically connected with an inverter 490 that is configured to convert direct current (DC) to alternating current (AC) and supply excess electricity to an external power grid. A remote access and control system 480 can be configured for wired or wireless network connectivity to enable a user to adjust display settings, chamber rotation and/or irrigation intervals. An integrated sensor system 485 can be provided to detect sunlight, temperature and/or humidity, and to adjust chamber rotational position based on the sensor data.

A façade greenery panel may be configured to support a sedum, succulent, or hydroponic plant life species. The disclosed system may prefer plants requiring less water, lower maintenance, drought tolerance, slow growth, and lower maturity height. The irrigation system can provide water and nutrients to the façade greenery while also cleaning the solar arrays. Solar arrays can provide power to the entire system, making it self-sufficient. The system may also give some power back to the grid. The LED or LCA panel system may provide a space for messaging, advertising, announcements, artwork, or building accentuation. It may be powered by energy collected by the solar arrays, shore power, or stored power. Each unit of a plurality of multi-sided chambers can have a motor-driven rotatable drive transmission and may be connected to another unit or a plurality of units to create a larger composite display, solar array, greenery area, or art/display piece.

### Energy Efficiency Benefit

Structures equipped with solar charging may achieve energy independence by generating their own renewable energy and reducing dependence on the grid. The energy may then be used to power the LED or LCA panels, motor(s), speakers, and irrigation system capable of watering the plants and cleaning the solar arrays. Green façade and solar charging units may help to reduce the energy consumption of a structure it is mounted upon, such as a building, by providing shading and insulation. This reduces the heat absorption and energy use of HVAC units.

### Reduced Carbon Footprint Benefit

Structures equipped with solar charging may significantly reduce their carbon footprint by using clean, renewable energy and reducing energy consumption.

### Communication and Advertising Function

The LED or LCA panels may provide advertising space, public announcements, emergency messages, or accentuate a building.

### Air Quality Benefit

Green façade units may improve the air quality around a structure it is mounted by filtering pollutants and particulate matter. The plants may absorb carbon dioxide and other harmful gases while releasing oxygen into the atmosphere.

### Noise Absorption Benefit

Urban environments constitute widespread disturbances and noises that considerably affect human health and well-being. Exterior and interior structure mounted systems, for example, on architectural buildings or roofs, improve overall urban acoustic comfort and contribute to reducing noise pollution caused by traffic, human activities, and street canyon scenarios. Street canyons are long stretches of high-rise buildings on both sides of the street that cause a ricochet or noise tunnel effect.

### The Benefit of Reduction of the Heat Island Effect

Densely populated urban areas with buildings, concrete, paved surfaces, and reflective glass generate higher levels of thermal mass and heat concentration throughout the day. The materials absorb the heat and are not quickly released. In addition, urban environments have higher levels of air pollution and lack trees and green spaces, which provide shade and heat absorption throughout the day. Solar arrays and façade greenery provide shading to help reduce heat and absorb direct sun radiation from buildings and surfaces.

### Aesthetic Benefits

Green façade units may enhance the aesthetics of structures and buildings by adding a layer of greenery and vegetation. Plants, artwork, or design features may create a natural and visually appealing appearance that blends with the surrounding environment. This may improve a person's mood, health, and well-being.

### Sustainable Building Design Benefit

Building adaptability is the capacity of a building to be used for multiple uses and in various ways over the life of the building. For example, designing a building with a modular and integrated approach to infrastructure delivery and interior systems (furniture, ceiling systems, demountable partitions, and access floors) allows the building to support multiple uses and futures. Sustainable design strategies and technologies enable a building to adapt to different environments and conditions. Adaptive façades can adjust to changing conditions, including short-term weather fluctuations or seasonal patterns, contributing to reducing heat gain and energy loads.

Building resiliency is the capacity of a building to continue to function and operate under extreme conditions, such as (but not limited to) extreme temperatures, sea level rise, natural disasters, and man-made hazards, including terrorism, etc. Building owners, designers, and builders must design facilities to optimize building resiliency as the built environment faces the impending effects of global climate change.

### Botanical Greenery Sub-System

The façade greenery panel and sub-system are intended to support plants that are low maintenance, drought tolerant, slow growing, and reach a low maturity height. A horticultural specialist can determine plant species or cultivators and make recommendations based on a customer project, application, climate, region, location, interior or exterior, side of the building, and direction of the sun or light exposure required. Plant species selection and horticultural experts can determine the optimal soil or substrate material for strong root growth, nutrition or PH balance, daily, weekly, or seasonal watering and maintenance schedule. The plants may be grown in a variety of substrate materials. A landscape architect or horticultural specialist can determine specifics. An example may include but is not limited to coconut mesh with a sandy soil base or similar product. The plant and growth media may sit in an interchangeable, mountable, or removable tray/bin for easier maintenance.

### Irrigation

Soft, lightweight plastic irrigation tubing combined with micro sprayers and valves control water flow and spray all sides of multisided module chambers. The irrigation system can be designed to support sustainability and conserve water.

### Horticulture Tray

Replaceable/exchangeable tray/bin can be used for the façade greenery. Each tray/bin may have multiple shelves with drainage holes for plants to be displayed. The tray/bin shelves may be arranged upward to support drainage and help secure the plants and substrate materials while protecting the plants.

### Visual Communication Display Panel Sub-System

Visual communication display panels may employ, for example, TLS™ LumiGrid™ lighting systems: Architectural low-energy lighting, lightweight LED lattice with stainless steel cables, substrate-free, point-to-point tension, narrow, lightweight lattice style lighting with stainless steel cables, and/or LED sheet designs that are highly versatile and customized in any shape and size. The display panels are preferably capable of tolerating extreme weather conditions. Examples of weather-tolerant displays include Nanolumens™ CLRVU Series™, LED panels featuring IP-65 Weather rating, front serviceability, auto brightness adjustments, and 20% higher brightness levels than other products on the market. The display panels can be controlled and linked together to form a single message or image.

### Solar Charging Sub-System

Suitable solar panels for the disclosed systems are commercially available from First Solar™ (e.g., Cadmium Telluride Photovoltaic Thin Film). Such panels are lightweight and produce more energy than traditional monocrystalline or polycrystalline panels, providing fast energy payback time while representing one of the most eco-efficient solutions on the market. Another suitable solar panel is commercially available from SunPower™ (e.g., Maxeon™ Flexible Solar Panels, which are lightweight and flexible with a high-power output while using cells resistant to power loss via cracking, corrosion, bending, or when subject to moist environment).

### Electrical System Design

The systems of this disclosure can include a battery for storing energy produced by the solar cells to provide the ability to create as much energy as the panel/system may consume and, optionally, the ability to feed energy back to the grid.

An integrated sensor system can be provided, which includes one or more sensors selected from sunlight detectors, temperature sensors, and humidity sensors.

The LED or LCA panels can be controlled at a single connection point with multiple panels connected to display a large image across multiple system units. The systems of the disclosure can be controlled by an app, tablet, or computer by creating a single access point for users. A user interface can be provided to control turning the units so solar, LED or LCA, façade greenery, artwork/design features, or speakers are facing outward away from the structure; setting timers for automatic rotation, manually spraying system (plants LED or LCA, solar arrays); setting timers for sprayers to function; setting time of day for sprayers to activate; setting LED or LCA output (text, images, LED or LCA colors) to be displayed; and/or setting volume for speakers.

A remote access and control system can also be provided, which is confirmed for wired or wireless network connectivity to allow a user to adjust display settings, manage chamber rotations, monitor weather conditions, sensor data and irrigation, such as via a mobile application. The control system can be configured to adjust rotational speed of the chambers and direction of rotation, such as in response to environmental conditions, or user preferences.

### Electrical System Components

An electric motor with positional feedback may control the rotations of each individual unit. All multi-sided chambers of a single system can rotate together, or individual multi-sided chambers may rotate independently of each other, allowing for further mixing and matching of display (LED or LCA, solar, façade greenery, artwork/design feature, speakers). When the unit motor(s) is not powered, it may activate a lock to limit the rotation of the unit in both normal conditions and extreme conditions (tornado, hail/ice storm, thunderstorm, hurricane, dust storm). A solar inverter may convert direct current (DC) electricity to alternating current (AC) electricity, which the electrical grid may use when the power output of the solar array exceeds what the unit needs and may store. A stationary battery pack may power the unit when the solar arrays are not producing electricity, and the battery may be charged when the solar arrays produce energy. The battery may be sized to run the motor(s), LED or LCA panels, irrigation, speakers, cameras, and electrical systems overnight or in cloudy conditions when the solar arrays are not producing much energy.

### System Overview

Components of the system (for example, Plants/LED or LCA/solar, art/design feature, speakers) can be arranged without any vertical mismatch (e.g., all greenery, LED or LCA, LED or LCA, solar, art/design feature or speakers) or components can be mixed or mismatched if desired.

### System Design

The system units are self-sustaining and may be continuously linked together to create larger displays, green areas, solar generating systems, or artwork/design features. Each multi-sided chamber may rotate as a single column. The multi-sided chambers may also rotate in tandem as a single column. All multi-sided chambers can be configured to communicate, wired or wirelessly, with each other to allow the unit to rotate together, or individual multi-sided chambers can rotate independently, allowing for further mixing and matching of display (LED or LCA, solar arrays, façade greenery, artwork/design feature, speakers).

The system may be designed such that the multi-sided chambers include any number of display panels, botanical green panels, solar charging panels, artwork/design features, or speakers. For example, a design with two solar charging panels and a botanical green panel on a three-panel multi-sided chamber may be provided. In another example, a design with two botanical green panels and a single artwork/design feature on a three-panel multi-sided chamber can be provided. In a further example, a design with all botanical green panels on a three-panel multi-sided chamber can be provided. The combination of display panels, botanical green panels, solar charging panels, artwork/design features, and speakers is not limited to the above-described examples. It may be provided in any combination to any size or number of sides of a multi-sided chamber (e.g., four, five, or six-sided chambers can be provided).

Rotational direction can be controlled by the current applied to the motor. For example, wind direction could determine the rotation direction to help reduce the wind loads applied to the unit when turning. Location or directional placement could dictate the rotation direction of a project to help follow the sun's rising and setting path (sun tracking). Corrosion life may depend on site conditions, mounting, and other variables. Materials that may be used include, but are not limited to, plastic, aluminum, steel, and carbon fiber. Coastal salt air regions may need coatings to protect against corrosion.

The multi-sided chambers may be designed to meet all building codes, environmental, and industry-standard noise ratings for interior or exterior industrial systems. The system may be designed to meet all building codes and standards necessary for commercial construction while also supporting LEED certification.

Frame system 100 can be fabricated from extruded aluminum. The structure may be strong enough to withstand normal conditions and extreme conditions (tornado, hail/ice storm, thunderstorm, hurricane, dust storm) while designed to meet all building codes and standards. The structure may have a raw extruded look or can be painted as desired. During extreme weather conditions such as hail, ice, and wind gusts, solar arrays may face outward (flat) to protect the unit, as solar arrays are more tolerant to inclement weather. The system may feature an automated feedback system during storms so that the system can default to solar arrays outward and flat, flush, with no angle pointing outward. LED or LCA, façade greenery, artwork/design features, and speakers can face inward during inclement weather.

The system may be mounted to the interior and/or exterior of an architectural building, to a detached frame structure, separate from a building, next to a building, or completely independent of a building. The system may also be mounted in an entertainment environment, such as theme parks, staging, exhibition centers, outdoor theaters, venues, or roof-top dining areas. The system may also be mounted on civil structures, for example, bridges, billboards, road signage/overpasses, sports arenas, stadiums, or airports. The system may also be mounted as architectural artwork or as a part of artwork installations. The system may be attached to interior portions of structures, both on vertical structures, for example, walls or vertical support members, and horizontal support structures, for example, ceilings, rooftops, or horizontal support structures.

The disclosed systems and units have been described with reference to specific arrangements and configurations. However, the illustrative examples provided herein are not intended to be exhaustive or to limit embodiments of the disclosed subject matter to the precise forms disclosed. Various modifications may be used without departing from the scope or content of the disclosure and claims presented herein.

What is claimed is:

1. A modular unit for use in an architectural façade system comprising:
a frame having a front side;
at least one multi-sided chamber rotatably mounted on the frame;
a transmission configured to transfer output from a motor to cause rotational movement of the multi-sided chamber;
a controller for operating the motor to position a particular side of the multi-sided chamber at the front side of the frame; and
wherein a first of the sides of the multi-sided chamber holds a solar array.

2. The modular unit of claim 1, wherein the controller is mounted remote from the frame.

3. The modular unit of claim 1, wherein there are a plurality of multi-sided chambers rotatably mounted on the frame, and the transmission is configured to transfer rotational output from the motor to each of the multi-sided chambers to effect synchronous rotational movement of the plurality of multi-sided chambers.

4. The modular unit of claim 1, wherein the multi-sided chamber has three planar sides, with the edges of each planar side joined to the edges of another planar side to form a triangular prism structure.

5. The modular unit of claim 1, wherein a second of the sides of the multi-sided chamber holds a light-emitting electronic display.

6. The modular unit of claim 5, wherein the light-emitting electronic display is a light-emitting diode (LED) display device.

7. The modular unit of claim 1, wherein a second of the sides of the multi-sided chamber holds a greenery bin or tray.

8. The modular unit of claim 1, further comprising a battery fixed to the frame for storing energy collected by the solar array and powering the motor.

9. The modular unit of claim 4, wherein a second side of the multi-sided chamber holds a light-emitting electronic display, and a third side of the multi-sided chamber holds a greenery bin or tray.

10. The modular unit of claim 1, further comprising an irrigation system configured to spray water at the side of the multi-sided chamber.

11. The modular unit of claim 1, wherein at least one of the multi-sided chambers holds at least one speaker.

12. An architectural façade system comprising a plurality of the modular units of claim 1 arranged in a plurality of rows and a plurality of columns.

13. A modular unit for use in an architectural façade system, comprising:
a frame having a front side;
at least one multi-sided chamber rotatably mounted on the frame;
a transmission configured to receive output from a motor to cause rotational movement of the multi-sided chamber;
a controller for operating the motor to position a particular side of the multi-sided chamber at the front side of the frame; and
wherein a first of the sides of each of the multi-sided chambers holds a light-emitting electronic display.

14. A modular unit for use in an architectural façade system, comprising:
a frame having a front side;
at least one multi-sided chamber rotatably mounted on the frame;
a transmission configured to receive output from a motor to cause rotational movement of the multi-sided chamber;
a controller for operating the motor to position a particular side of the multi-sided chamber at the front side of the frame; and
wherein a first of the sides of each of the multi-sided chambers holds a greenery bin or tray.

15. The modular unit of claim 1, configured to provide a weather-resistant casing to shield internal components from adverse weather conditions, and wherein the multi-sided chambers are rotatable and capable of locking in position to protect internal components during severe weather.

16. The modular unit of claim 1, further comprising a remote access and control system configured for wired or wireless network connectivity, wherein the system enables users to adjust at least one of display settings, chamber rotations, weather conditions, sensor data, and irrigation intervals.

17. The modular unit of claim 1, wherein the controller is configured to adjust at least one of the rotational speed and direction of the multi-sided chambers.

18. The modular unit of claim 1, further comprising an integrated sensor system, wherein the sensors are configured to detect at least one of sunlight, temperature, and humidity, and wherein the controller automatically adjusts the rotational positions of the multi-sided chambers based on sensor data.

19. The modular unit of claim 1, wherein a plurality of modular units are configured to communicate wirelessly with one another for synchronized rotational movement and coordinated display functionality.

20. The modular unit of claim 1, wherein the solar array is electrically connected to an inverter configured to convert direct current (DC) generated by the solar array into alternating current (AC) and supply excess electricity to an external power grid.
